(19) United States
(12) Patent Application Publication
(10) Pub. No.: US 2026/0296141 A1
(43) Pub. Date: Oct. 1, 2026

(54) REFRIGERATION CYCLE DEVICE

(71) Applicant: DENSO CORPORATION, Kariya-shi (JP)

(72) Inventors: Hiroyasu OIDE, Kariya-shi (JP); Naoki YOKOYAMA, Kariya-shi (JP); Hiroyoshi YAMAMOTO, Kariya-shi (JP)

(21) Appl. No.: 19/572,923

(22) Filed: Mar. 20, 2026

(30) Foreign Application Priority Data
Mar. 25, 2025 (JP) 2025-049949

(51) Int. Cl. B60H 1/32; B60H 1/00

(52) U.S. Cl. CPC B60H 1/32284; B60H 1/00328; B60H 1/00485; B60H 1/00885; B60H 2001/00928

(57) ABSTRACT

A refrigeration cycle device includes a radiator configured to radiate heat of refrigerant discharged from a compressor to a high temperature heat medium of a high-temperature heat medium circuit, a decompressor, a heat absorber, a heat supply target arranged in the high-temperature heat medium circuit, a heat transfer unit configured to transfer heat from the high-temperature heat medium circuit to a low-temperature heat medium circuit, and a flow rate ratio adjuster configured to adjust a flow ratio of a flow rate of the high temperature heat medium flowing in the heat transfer unit to a flow rate of the high temperature heat medium circulating in the high-temperature heat medium circuit. The flow rate ratio adjuster is controlled to cause the flow ratio to increase, as a density of the refrigerant, a heat amount of the high temperature heat medium, or a heat amount of the low temperature heat medium decreases.

### CROSS REFERENCE TO RELATED APPLICATION

The present application is based on and claims the benefit of priority of Japanese Patent Application No. 2025-049949, filed on Mar. 25, 2025, the disclosure of which is incorporated herein by reference.

### TECHNICAL FIELD

The present disclosure relates to a refrigeration cycle device.

### BACKGROUND

In a conventional refrigeration cycle device, coolant in a high temperature coolant circuit is heated by a high pressure refrigerant in a refrigeration cycle, and coolant in a low temperature coolant circuit is cooled by a low pressure refrigerant in the refrigeration cycle. A heater core is disposed in the high temperature coolant circuit, to heat air to be blown into a vehicle cabin by exchanging heat between air and the coolant in the high temperature coolant circuit.

### SUMMARY

According to an aspect of the present disclosure, a refrigeration cycle device of the present disclosure includes: a compressor configured to draw and discharge a refrigerant; a first heat exchanger in which the refrigerant discharged from the compressor exchanges heat with a high temperature heat medium to radiate heat to the high temperature heat medium; a decompression valve configured to decompress the refrigerant flowing out from the first heat exchanger; a second heat exchanger configured to exchange heat between the refrigerant decompressed in the decompression valve and a low temperature heat medium; a high-temperature heat medium circuit in which the high temperature heat medium circulates through the first heat exchanger; a heat supply target arranged in the high-temperature heat medium circuit to be supplied with heat from the high temperature heat medium; a low-temperature heat medium circuit in which the low temperature heat medium circulates through the second heat exchanger; a heat transfer heat exchanger configured to transfer heat from the high-temperature heat medium circuit to the low-temperature heat medium circuit; a flow adjustment valve configured to adjust a flow ratio of a flow rate of the high temperature heat medium flowing in the heat transfer heat exchanger to a flow rate of the high temperature heat medium circulating in the high-temperature heat medium circuit; and a controller including at least one of a circuit and a processor having a memory storing computer program code. The at least one of the circuit and the processor having the memory is configured to control the flow adjustment valve to cause the flow ratio to increase, as a density of the refrigerant, an amount of heat possessed by the high temperature heat medium, or an amount of heat possessed by the low temperature heat medium decreases.

### BRIEF DESCRIPTION OF THE DRAWINGS

Objects, features, and advantages of the present disclosure will become more apparent from the following detailed description made with reference to the accompanying drawings, in which:

FIG. 1 is a configuration diagram of a thermal management system according to a first embodiment;

FIG. 2 is a configuration diagram of an indoor air conditioning unit according to the first embodiment;

FIG. 3 is a block diagram of a control system of the thermal management system according to the first embodiment;

FIG. 4 is a flowchart relating to control of a high-temperature side flow rate adjustment valve according to the first embodiment; and

FIG. 5 is a flowchart relating to control of a bypass switching valve and a low-temperature side flow rate adjustment valve according to the first embodiment.

### DESCRIPTION OF EMBODIMENTS

In a refrigeration cycle device, coolant in a high temperature coolant circuit is heated by a high pressure refrigerant in a refrigeration cycle, and coolant in a low temperature coolant circuit is cooled by a low pressure refrigerant in the refrigeration cycle. A heat exchanger arranged in the high temperature coolant circuit and a heat exchanger arranged in the low temperature coolant circuit are joined to each other by common fins so that heat can be transferred from the high temperature coolant circuit to the low temperature coolant circuit.

When starting an operation of a refrigeration cycle in a low temperature environment, the refrigerant has a low temperature and a low density (i.e., low pressure). In this case, a compression workload of a compressor may be reduced thereby taking a longer time to generate a desired amount of heat, or it may be impossible to start the compressor at all for generating the desired amount of heat.

Even in a situation of starting the refrigeration cycle in a low temperature environment, the heat can be transferred from the high temperature coolant circuit to the low temperature coolant circuit, and the temperature and density of the low pressure refrigerant can be increased because the low pressure refrigerant in the refrigeration cycle absorbs heat from the coolant in the low temperature coolant circuit. Thus, the compression workload of the compressor can be obtained.

However, while transferring heat from the high temperature coolant circuit to the low temperature coolant circuit, the pressure of the low pressure refrigerant may rise too much, thereby it make the state of the refrigeration cycle unstable or it may be difficult for the heater core arranged in the high temperature coolant circuit to obtain the required amount of heat.

In view of the above, it is an object of the present disclosure to provide a refrigeration cycle device that is capable of appropriately transferring heat from a high-temperature heat medium circuit to a low-temperature heat medium circuit.

According to an aspect of the present disclosure, a refrigeration cycle device of the present disclosure includes: a compressor configured to draw and discharge a refrigerant; a radiator in which the refrigerant discharged from the compressor exchanges heat with a high temperature heat medium to radiate heat to the high temperature heat medium; a decompressor configured to decompress the refrigerant flowing out from the radiator; a heat absorber configured to exchange heat between the refrigerant decompressed in the decompressor and a low temperature heat medium; a high-temperature heat medium circuit in which the high temperature heat medium circulates through the radiator; a heat supply target arranged in the high-temperature heat medium circuit to be supplied with heat from the high temperature heat medium; a low-temperature heat medium circuit in which the low temperature heat medium circulates through the heat absorber; a heat transfer unit configured to transfer heat from the high-temperature heat medium circuit to the low-temperature heat medium circuit; a flow rate ratio adjuster configured to adjust a flow ratio of a flow rate of the high temperature heat medium flowing in the heat transfer unit to a flow rate of the high temperature heat medium circulating in the high-temperature heat medium circuit; and a control unit configured to control the flow rate ratio adjuster to cause the flow ratio to increase, as a density of the refrigerant, an amount of heat possessed by the high temperature heat medium, or an amount of heat possessed by the low temperature heat medium decreases.

According to the above, heat possessed by the high temperature heat medium is transferred to the low temperature heat medium in the heat transfer unit to heat the low temperature heat medium, and the refrigerant in the refrigeration cycle is made to absorb heat from the low temperature heat medium in the heat absorber, thereby increasing the temperature of the refrigerant. In such manner, the density of the refrigerant in the refrigeration cycle is increased, thereby making it easier for the compressor to obtain a compression workload when starting the operation of the refrigeration cycle and making it easier for the refrigeration cycle to exhibit the desired capacity.

Further, the flow ratio of the flow rate of the high temperature heat medium in the heat transfer unit is made greater as the density of the refrigerant, the amount of heat possessed by the high temperature heat medium, or the amount of heat possessed by the low temperature heat medium becomes smaller, thereby making it possible to appropriately transfer heat from the high-temperature heat medium circuit to the low-temperature heat medium circuit.

Thus, the heat transfer from the high temperature heat medium to the low temperature heat medium is prioritized for the refrigeration cycle to exhibit its capacity when the priority of heat transfer from the high temperature heat medium to the low temperature heat medium is high, such as in a low temperature environment. Furthermore, it is also possible to prevent a situation of causing (i) an unstable state of the cycle due to excessive rise of the refrigerant pressure, or (ii) an insufficient supply of heat to the heat supply target in the high-temperature heat medium circuit, when the priority of heat transfer from the high temperature heat medium to the low temperature heat medium is low.

The following describes embodiments for carrying out the present disclosure with reference to the drawings. In each of the embodiments, portions corresponding to those described in the preceding embodiment are denoted by the same reference numerals, and overlapping descriptions may be omitted. When only a part of a configuration is described in each embodiment, the other, preceding embodiments described before are employable for the other parts of such configuration. The present disclosure, partially combining embodiments is possible not only the parts which are explicitly described as combinable, but also the parts which are not explicitly described as combinable, as long as no problem arises therefrom.

### First Embodiment

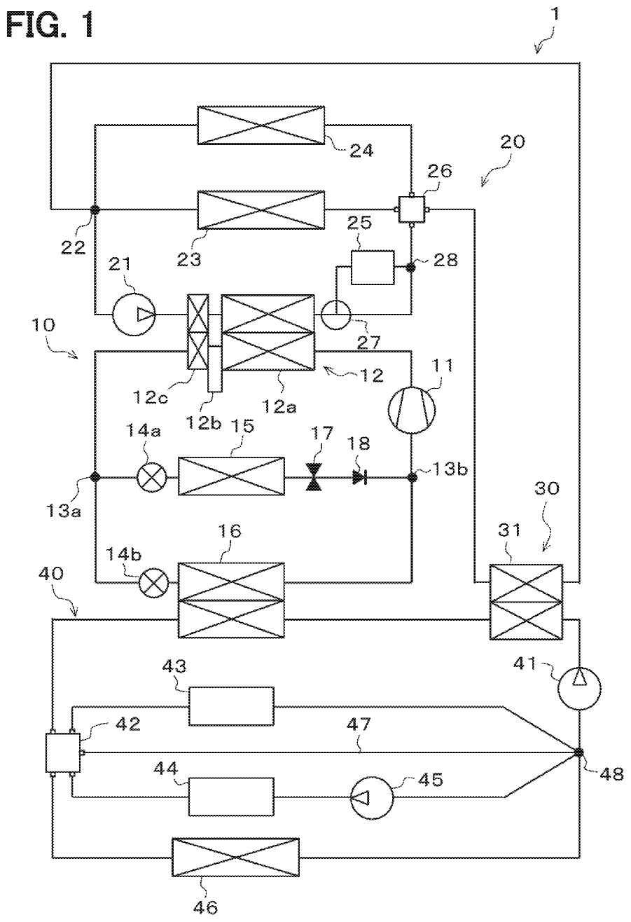

The first embodiment of the present disclosure will be described with reference to FIGS. 1 to 3. A thermal management system 1 according to the first embodiment is applied to an electric vehicle that obtains driving force for running the vehicle from an electric motor for running the vehicle. The thermal management system 1 constitutes a refrigeration cycle device that air-conditions the cabin of the vehicle, which is a space to be air-conditioned, and adjusts the temperature of devices including a battery 43 and the like in the electric vehicle. The thermal management system 1 can switch between a cooling mode, a heating mode, and a dehumidifying and heating mode as operation modes for air-conditioning the vehicle cabin.

A refrigeration cycle 10 in the thermal management system 1 uses an HFC refrigerant (specifically, R134a) as the refrigerant, and constitutes a subcritical refrigeration cycle in which a high pressure side refrigerant pressure does not exceed the critical pressure of the refrigerant. It is also possible to use R1234yf or the like as the refrigerant. A refrigerator oil for lubricating a compressor 11 is mixed in the refrigerant. As the refrigerator oil, polyalkylene glycol oil (PAG oil) having compatibility with a liquid-phase refrigerant is adopted. A part of the refrigerator oil circulates in a cycle together with the refrigerant.

Next, a specific configuration of the thermal management system 1 according to the first embodiment will be described with reference to FIG. 1. The thermal management system 1 includes the refrigeration cycle 10, a high-temperature heat medium circuit 20, a low-temperature heat medium circuit 40, a cabin air conditioning unit 50, and a control device 60.

First, the configuration of the refrigeration cycle 10 in the thermal management system 1 will be described. The refrigeration cycle 10 is a vapor compression type refrigeration cycle device. In the refrigeration cycle 10, the compressor 11 draws in, compresses, and discharges the refrigerant. The compressor 11 is arranged in a vehicle engine room.

The compressor 11 is an electric compressor that rotationally drives, by an electric motor, a fixed capacity type compression mechanism with a fixed discharge capacity. The rotation speed (i.e., a refrigerant discharge capacity) of the compressor 11 is controlled by a control signal output from the control device 60, which will be described later.

A discharge port of the compressor 11 is connected to an inlet port side of a refrigerant passage of a heat medium refrigerant heat exchanger 12. The heat medium refrigerant heat exchanger 12 is a heat exchanger that transfers heat from a high pressure refrigerant discharged from the compressor 11 to the heat medium in the high-temperature heat medium circuit 20 for heating.

The heat medium refrigerant heat exchanger 12 is configured as a so-called subcooling type condenser, and has a condensing section 12a, a receiver section 12b, and a supercooling section 12c. The condensing section 12a is a heat exchanger that exchanges heat between the high pressure refrigerant and the high temperature heat medium in the high-temperature heat medium circuit 20 to condense the refrigerant. The receiver section 12b is a liquid receiving section that stores the liquid-phase refrigerant flowing out from the condensing section 12a. The supercooling section 12c is a heat exchanger that exchanges heat between the liquid-phase refrigerant flowing out from the receiver section 12b and the high temperature heat medium in the high-temperature heat medium circuit 20 to supercool the liquid-phase refrigerant.

In such manner, a so-called receiver cycle is configured, and the high pressure liquid-phase refrigerant condensed in the condensing section 12a can be stored in the receiver section 12b as surplus refrigerant of the cycle. Therefore, the refrigerant flowing out from an inside evaporator 15 can be evaporated to a gas-phase refrigerant having a certain degree of superheat. By supercooling the refrigerant in the supercooling section 12c, an enthalpy difference between the enthalpy of the refrigerant on the outlet port side of the inside evaporator 15 and the enthalpy of the refrigerant on the inlet port side can be increased.

The heat medium refrigerant heat exchanger 12 corresponds to an example of a radiator. The high temperature heat medium in the high-temperature heat medium circuit 20 may be a solution containing ethylene glycol, an antifreeze solution, or the like.

The outlet port of the refrigerant passage of the heat medium refrigerant heat exchanger 12 is connected to the refrigerant inlet port side of the refrigerant branch portion 13a. The refrigerant branch portion 13a branches the flow of the liquid-phase refrigerant flowing out from the heat medium refrigerant heat exchanger 12. The refrigerant branch portion 13a is provided to have a three way joint structure including three refrigerant inlet/outlet ports communicating with each other. In the refrigerant branch portion 13a, one of the three inlet/outlet ports is a refrigerant inlet port, and the remaining two are refrigerant outlet ports.

One refrigerant outlet port of the refrigerant branch portion 13a is connected to the refrigerant inlet port side of the inside evaporator 15 via a first expansion valve 14a. The other refrigerant outlet port of the refrigerant branch portion 13a is connected to the refrigerant inlet port side of a chiller 16 via a second expansion valve 14b.

The first expansion valve 14a is a decompressor that reduces the pressure of the refrigerant that flows out from one refrigerant outlet port of the refrigerant branch portion 13a at least in a cooling mode. The first expansion valve 14a is an electric variable throttle mechanism, and includes a valve body and an electric actuator. That is, the first expansion valve 14a is a so-called electric expansion valve.

The valve body of the first expansion valve 14a is configured to be capable of changing the opening degree of the refrigerant passage (in other words, a throttle opening degree). The electric actuator includes a stepping motor that changes the throttle opening degree of the valve body. The operation of the first expansion valve 14a is controlled by a control signal output from the control device 60.

The first expansion valve 14a is composed of a variable throttle mechanism that has (i) a full opening function for fully opening the refrigerant passage when the opening degree of the refrigerant passage is set to full open, and (ii) a full closing function that closes the refrigerant passage when the opening degree of the refrigerant passage is set to full close. That is, when fully opening the refrigerant passage, the first expansion valve 14a does not exhibit a pressure reducing effect on the refrigerant.

The first expansion valve 14a can block the inflow of refrigerant into the inside evaporator 15 by closing the refrigerant passage. That is, the first expansion valve 14a functions as a decompressor that reduces the pressure of the refrigerant, and also functions as a refrigerant circuit switching unit that switches the refrigerant circuit.

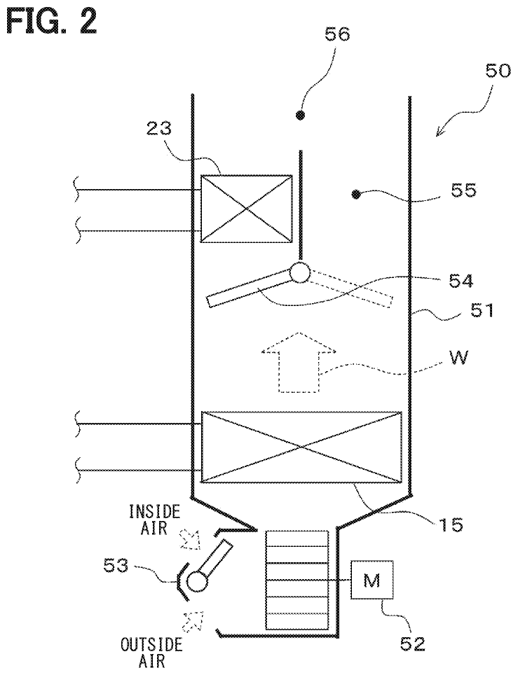

The refrigerant inlet port side of the inside evaporator 15 is connected to the outlet port of the first expansion valve 14a. As shown in FIG. 2, the inside evaporator 15 is arranged in a casing 51 of the cabin air conditioning unit 50. The inside evaporator 15 is an evaporator that, at least in the cooling mode, exchanges heat between the low pressure refrigerant decompressed by the first expansion valve 14a and an air W blown into the vehicle cabin to evaporate the low pressure refrigerant and cool the air W.

As illustrated in FIG. 1, the second expansion valve 14b is connected to the other refrigerant outlet port in the refrigerant branch portion 13a. The second expansion valve 14b is a decompressor that reduces the pressure of the refrigerant flowing out from the other refrigerant outlet port of the refrigerant branch portion 13a at least in the heating mode, and corresponds to an example of a decompressor.

Similarly to the first expansion valve 14a, the second expansion valve 14b is an electric variable throttle mechanism, and includes a valve body and an electric actuator. That is, the second expansion valve 14b includes a so-called electric expansion valve, and has a fully opening function and a fully closing function.

That is, the second expansion valve 14b does not exhibit a pressure reducing effect on the refrigerant when fully opening the refrigerant passage. The second expansion valve 14b can block the inflow of refrigerant into the chiller 16 by closing the refrigerant passage. That is, the second expansion valve 14b has both a function as a decompressor that reduces the pressure of the refrigerant and a function as a refrigerant circuit switching unit that switches the refrigerant circuit.

An outlet port of the second expansion valve 14b is connected to the refrigerant inlet port side of the chiller 16. The chiller 16 is a heat exchanger that exchanges heat between the low pressure refrigerant decompressed by the second expansion valve 14b and the low temperature heat medium circulating through the low-temperature heat medium circuit 40. The chiller 16 corresponds to an example of a heat sink.

The chiller 16 includes (i) a refrigerant passage through which the low pressure refrigerant decompressed by the second expansion valve 14b flows, and (ii) a heat medium passage through which the heat medium circulating in the low-temperature heat medium circuit 40 flows. Therefore, the chiller 16 evaporates the low pressure refrigerant flowing through the refrigerant passage and absorbs heat from the low temperature heat medium flowing through the heat medium passage through heat exchange between the low pressure refrigerant flowing through the refrigerant passage and the low temperature heat medium flowing through the heat medium passage.

The refrigerant outlet of the inside evaporator 15 is connected to the inlet port side of an evaporation pressure adjusting valve 17. The evaporation pressure adjusting valve 17 is an example of an evaporation pressure adjustment unit that maintains the refrigerant evaporation pressure in the inside evaporator 15 at a predetermined reference pressure or higher. The evaporation pressure adjusting valve 17 includes a mechanical variable throttle mechanism that increases the valve opening degree as the refrigerant pressure on the outlet port side of the inside evaporator 15 increases.

The evaporation pressure adjusting valve 17 is configured to maintain the refrigerant evaporation temperature in the inside evaporator 15 at a reference temperature (for example, 1 degree of Celsius in the present embodiment) or higher that can prevent frost from forming on the inside evaporator 15.

The outlet of the evaporation pressure adjusting valve 17 is connected to the inlet port side of a check valve 18. The check valve 18 allows the refrigerant to flow from the outlet port side of the evaporation pressure adjusting valve 17 toward a refrigerant merging portion 13b, and prohibits the refrigerant from flowing from the refrigerant merging portion 13b toward the outlet port side of the evaporation pressure adjusting valve 17.

The outlet port side of the check valve 18 is connected to one of refrigerant inlet ports of the refrigerant merging portion 13b. As shown in FIG. 1, the refrigerant outlet port side of the chiller 16 is connected to the other one of the refrigerant inlet ports of the refrigerant merging portion 13b.

The refrigerant merging portion 13b includes a three way joint structure similar to that of the refrigerant branch portion 13a, and two of three inlet/outlet ports are used as refrigerant inlet ports and the remaining one is used as a refrigerant outlet port. The refrigerant merging portion 13b combines the flow of refrigerant flowing out from the evaporation pressure adjusting valve 17 and the check valve 18 with the flow of refrigerant flowing out from the chiller 16. The inlet port side of the compressor 11 is connected to the refrigerant outlet port of the refrigerant merging portion 13b.

Next, the configuration of the high-temperature heat medium circuit 20 in the thermal management system 1 will be described. The high-temperature heat medium circuit 20 is a heat medium circuit that circulates a heat medium. The heat medium in the high-temperature heat medium circuit 20 may be a solution containing ethylene glycol, an antifreeze solution, or the like.

The high-temperature heat medium circuit 20 includes a heat medium passage of the heat medium refrigerant heat exchanger 12, a high-temperature side pump 21, a high-temperature side connection part 22, a heater core 23, a radiator 24, a high-temperature side on-board equipment 25, a high-temperature side flow rate adjustment valve 26, a bypass switching valve 27, a bypass connection part 28, a heat transfer unit 30, and the like.

As shown in FIG. 1, a discharge port of a high-temperature side pump 21 is connected to the inlet port side of the heat medium passage in the heat medium refrigerant heat exchanger 12. The high-temperature side pump 21 is a heat medium pump that pumps the high temperature heat medium in the high-temperature heat medium circuit 20 for circulation. The high-temperature side pump 21 discharges and pressure-feeds the high temperature heat medium to the heat medium passage in the heat medium refrigerant heat exchanger 12. The high-temperature side pump 21 is an electric pump whose rotation speed (i.e., pumping capacity) is controlled by a control voltage output from the control device 60.

The high-temperature side connection part 22 is connected to a suction port of the high-temperature side pump 21. The high-temperature side connection part 22 is formed as a four-way joint having four inlet/outlet ports. Of the four inlet/outlet ports of the high-temperature side connection part 22, three of the inlet/outlet ports serve as inlet ports for the high temperature heat medium, and the other one of the inlet/outlet ports serves as an outlet port for the high temperature heat medium.

One of the inlet ports of the high-temperature side connection part 22 is connected to the heat medium outlet port side of the heater core 23, and the other one of the inlet ports of the high-temperature side connection part 22 is connected to the heat medium outlet port side of the radiator 24. The yet other one of the inlet ports of the high-temperature side connection part 22 is connected to the outlet port side of a high temperature heat medium passage in a heat medium heat exchanger 31 constituting a heat transfer unit 30, which will be described later.

The heater core 23 is a heat exchanger that heats the air W by exchanging heat between the high temperature heat medium heated by the heat medium refrigerant heat exchanger 12 or the like and the air W that has passed through the inside evaporator 15. The heater core 23 is a heat supply target to which heat is supplied from the high temperature heat medium. As shown in FIG. 2, the heater core 23 is arranged in the casing 51 of the cabin air conditioning unit 50. The heater core 23 corresponds to an example of a heating heat exchanger, and the air W corresponds to an example of an object to be heated.

The radiator 24 is a heat exchanger that exchanges heat between a heat medium heated by the heat medium refrigerant heat exchanger 12 or the like and an outside air OA blown by an outside air fan (not shown), thereby dissipating the heat possessed by the heat medium to the outside air OA.

The radiator 24 is arranged on the front side under the hood of the vehicle. As the above-described outside air fan is operated, the outside air OA flows from the front side of the vehicle to the rear side, passing through the heat exchange unit of the radiator 24. When the vehicle is traveling, the traveling wind can be directed from the front side of the vehicle to the rear side toward the radiator 24.

In the heat transfer unit 30, heat transfer occurs between the high temperature heat medium circulating through the high-temperature heat medium circuit 20 and the low temperature heat medium circulating through the low-temperature heat medium circuit 40. In the example of the present embodiment, the heat transfer unit 30 is the heat medium heat exchanger 31.

The heat medium heat exchanger 31 is a heat exchanger that exchanges heat between the high temperature heat medium and the low temperature heat medium, and transfers heat possessed by the high temperature heat medium to the low temperature heat medium. The heat medium heat exchanger 31 includes (a) a high temperature heat medium passage through which a high temperature heat medium flows and which constitutes a part of the high-temperature heat medium circuit 20, and (b) a low temperature heat medium passage through which a low temperature heat medium flows and which constitutes a part of the low-temperature heat medium circuit 40.

The heat medium heat exchanger 31 is made of the same type of metal (aluminum alloy in the present embodiment) that has excellent heat conductivity, and each component is integrated by brazing. In such configuration, the high temperature heat medium flowing through the high temperature heat medium passage and the low temperature heat medium flowing through the low temperature heat medium passage exchange heat with each other, thereby allowing heat of the high temperature heat medium to be transferred to the low temperature heat medium.

As shown in FIG. 1, the bypass switching valve 27 is arranged on the outlet port side of the heat medium passage in the heat medium refrigerant heat exchanger 12. The bypass switching valve 27 is a high-temperature side switching unit that switches the flow of the high temperature heat medium in the high-temperature heat medium circuit 20.

The bypass switching valve 27 is configured as an electric three-way valve having three inlet/outlet ports. The bypass switching valve 27 uses one of the three inlet/outlet ports as a heat medium inlet port and the other two as heat medium outlet ports.

One of the heat medium outlet ports of the bypass switching valve 27 is connected to the heat medium inlet port side of the high-temperature side on-board equipment 25, and the other one of the heat medium outlet ports of the bypass switching valve 27 is connected to one of the heat medium inlet port sides of the bypass connection part 28.

The bypass connection part 28 is formed as a three-way joint having three inlet/outlet ports. The bypass connection part 28 has three inlet/outlet ports, two of which serve as inlet ports for the high temperature heat medium, and one of which serves as an outlet port for the high temperature heat medium.

The other one of the heat medium inlet ports of the bypass connection part 28 is connected to the heat medium outlet port side of the high-temperature side on-board equipment 25.

Therefore, in the high-temperature heat medium circuit 20, the flow of the high temperature heat medium discharged from the high-temperature side pump 21 and circulating through the heat medium refrigerant heat exchanger 12 can be switched by the bypass switching valve 27 between (i) passing through the high-temperature side on-board equipment 25 and (ii) bypassing the high-temperature side on-board equipment 25.

The high-temperature side on-board equipment 25 is a high-temperature side heat supply unit that supplies heat to the high temperature heat medium in the high-temperature heat medium circuit 20. The high-temperature side on-board equipment 25 is, for example, an electric heater 25a. The electric heater 25a is a heating device that generates heat when supplied with electric power and heats the high temperature heat medium circulating through the high-temperature heat medium circuit 20. As the electric heater 25a, for example, a PTC heater having a PTC element (i.e., a positive temperature coefficient thermistor) can be used. The electric heater 25a can arbitrarily adjust the amount of heat for heating the high temperature heat medium by a control voltage output from the control device 60.

In case where the electric vehicle to which the thermal management system 1 is applied is a fuel cell vehicle in which electric power is supplied from a fuel cell to an electric motor for driving, the high-temperature side on-board equipment 25 may be a fuel cell stack.

When the thermal management system 1 is applied to a vehicle that obtains driving force for running the vehicle from an engine (in other words, an internal combustion engine), the high-temperature side on-board equipment 25 may be the engine or an exhaust pipe.

The high-temperature side flow rate adjustment valve 26 is arranged on the heat medium outlet port side of the bypass connection part 28. The high-temperature side flow rate adjustment valve 26 is a flow rate ratio adjuster that adjusts the ratio of (i) the flow rate of the high temperature heat medium in the heat transfer unit 30 to (ii) the total flow rate of the high temperature heat medium circulating in the high-temperature heat medium circuit 20.

The high-temperature side flow rate adjustment valve 26 is configured as an electric four-way flow rate adjustment valve having four inlet/outlet ports, and corresponds to an example of a high-temperature side flow rate adjustment unit. The high-temperature side flow rate adjustment valve 26 has four inlet/outlet ports, one of which is used as a heat medium inlet port, and the other three are used as heat medium outlet ports.

One of the heat medium outlet ports of the high-temperature side flow rate adjustment valve 26 is connected to the heat medium inlet port side of the heater core 23, and the other one of the heat medium outlet ports of the high-temperature side flow rate adjustment valve 26 is connected to the heat medium inlet port side of the radiator 24. The yet other one of the heat medium outlet ports of the high-temperature side flow rate adjustment valve 26 is connected to the inlet port side of the high temperature heat medium passage of the heat medium heat exchanger 31. As described above, the heat medium inlet port of the high-temperature side flow rate adjustment valve 26 is connected to the heat medium outlet port side of the bypass connection part 28.

Therefore, in the high-temperature heat medium circuit 20, with regard to the flow of the high temperature heat medium discharged from the high-temperature side pump 21 and circulating through the heat medium refrigerant heat exchanger 12, the flow rate balance is adjustable among (i) the flow rate passing through the heater core 23, (ii) the flow rate passing through the radiator 24, and (iii) the flow rate passing through the heat medium heat exchanger 31, which is the heat transfer unit 30.

For example, the high-temperature side flow rate adjustment valve 26 can adjust the ratio of (i) the flow rate passing through the heat medium heat exchanger 31 (hereinafter referred to as a heat transfer unit flow rate ratio) to (ii) the flow rate of the high temperature heat medium discharged from the high-temperature side pump 21 and circulating through the heat medium refrigerant heat exchanger 12 (in other words, the flow rate of the high temperature heat medium circulating through the high-temperature heat medium circuit 20) in the range of 0% to 100%.

That is, when the high-temperature side flow rate adjustment valve 26 fully closes the heat medium outlet port on a side of a heat medium heat exchanger 31, no high temperature heat medium flows into the heat medium heat exchanger 31, thereby adjusting the heat transfer unit flow rate ratio to 0%.

On the other hand, when the high-temperature side flow rate adjustment valve 26 fully closes the heat medium outlet port on a heater core 23 side and the heat medium outlet port on a radiator 24 side, and opens the heat medium outlet port on the heat medium heat exchanger 31 side, the entire flow rate of the high temperature heat medium discharged from the high-temperature side pump 21 and circulating through the heat medium refrigerant heat exchanger 12 passes through the heat medium heat exchanger 31, thereby adjusting the heat transfer unit flow rate ratio to 100%.

When the high-temperature side flow rate adjustment valve 26 opens at least one of the heat medium outlet port on the heater core 23 side and the heat medium outlet port on the radiator 24 side, and also opens the heat medium outlet port on the heat medium heat exchanger 31 side, the heat transfer unit flow rate ratio becomes an intermediate ratio greater than 0% and less than 100%, depending on the balance of the opening degrees of each of the heat medium outlet ports of the high-temperature side flow rate adjustment valve 26.

In the high-temperature heat medium circuit 20, a reserve tank may be arranged at the position of the high-temperature side connection part 22 shown in FIG. 1. The reserve tank is a heat medium storage unit that stores excess high temperature heat medium. By storing an excess of high temperature heat medium in the reserve tank, it is possible to suppress a decrease in the amount of high temperature heat medium circulating through the high-temperature heat medium circuit 20. The reserve tank functions as a heat medium supply port for supplying high temperature heat medium when the amount of high temperature heat medium in the high-temperature heat medium circuit 20 becomes insufficient.

Next, the configuration of the low-temperature heat medium circuit 40 in the thermal management system 1 is described. The low-temperature heat medium circuit 40 is a heat medium circuit that circulates a low temperature heat medium. As the low temperature heat medium in the low-temperature heat medium circuit 40, the same fluid as that in the high-temperature heat medium circuit 20 is usable.

The low-temperature heat medium circuit 40 includes a heat medium passage of the chiller 16, a low temperature heat medium passage of the heat medium heat exchanger 31, a first low-temperature side pump 41, a low-temperature side flow rate adjustment valve 42, a battery 43, a low-temperature side on-board equipment 44, a second low-temperature side pump 45, an outside air heat exchanger 46, and the like.

As shown in FIG. 1, a discharge port side of the first low-temperature side pump 41 is connected to an inlet port of the low temperature heat medium passage in the heat medium heat exchanger 31 which is the heat transfer unit 30. The first low-temperature side pump 41 is a heat medium pump that pumps the low temperature heat medium in the low-temperature heat medium circuit 40 to the inlet port side of the low temperature heat medium passage of the heat medium heat exchanger 31. The basic configuration of the first low-temperature side pump 41 is similar to that of the high-temperature side pump 21.

As described above, the heat medium heat exchanger 31 is configured to be capable of exchanging heat between the high temperature heat medium flowing through the high temperature heat medium passage and the low temperature heat medium flowing through the low temperature heat medium passage. Therefore, the heat medium heat exchanger 31 can transfer heat of the high temperature heat medium to the low temperature heat medium, and constitutes the heat transfer unit 30.

An outlet port side of the low temperature heat medium passage of the heat medium heat exchanger 31 is connected to an inlet port of the heat medium passage of the chiller 16. Therefore, the low temperature heat medium that has received heat from the high temperature heat medium in the heat transfer unit 30 flows directly into the chiller 16. As described above, the refrigerant passage and the heat medium passage in the chiller 16 are configured to exchange heat therebetween, so that the heat of the low temperature heat medium can be absorbed by the refrigerant flowing through the refrigerant passage.

A low-temperature side flow rate adjustment valve 42 is connected to the outlet port side of the heat medium passage in the chiller 16. The low-temperature side flow rate adjustment valve 42 is a low-temperature side switching unit that switches the flow of the low temperature heat medium in the low-temperature heat medium circuit 40.

The low-temperature side flow rate adjustment valve 42 is configured as an electric five-way flow rate adjustment valve having five inlet/outlet ports, and corresponds to an example of a low-temperature side flow rate adjuster. The low-temperature side flow rate adjustment valve 42 has five inlet/outlet ports, two of which are used as heat medium inlet ports and three of which are used as heat medium outlet ports. The outlet port side of the heat medium passage in the chiller 16 is connected to one of the heat medium inlet ports of the low-temperature side flow rate adjustment valve 42.

One of the heat medium outlet ports of the low-temperature side flow rate adjustment valve 42 is connected to the inlet port side of the heat medium passage of the battery 43. The battery 43 supplies electric power to various electrical devices of the vehicle, and is, for example, a rechargeable secondary battery (in the present embodiment, a lithium ion battery). The heat medium passage for the battery 43 is formed in a cover of the battery 43, and by passing a low temperature heat medium through it, the temperature of the battery 43 can be adjusted and maintained within a predetermined temperature range. Therefore, the battery 43 corresponds to a temperature adjuster including the secondary battery body as a temperature adjustment target. A low-temperature side connection part 48 is arranged on the outlet port side of the heat medium passage of the battery 43.

The other one of heat medium inlet ports of the low-temperature side flow rate adjustment valve 42 is connected to the outlet port side of the heat medium passage of the low-temperature side on-board equipment 44. The low-temperature side on-board equipment 44 is mounted on the electric vehicle and is composed of equipment that generates heat when in operation. The low-temperature side on-board equipment 44 is a low-temperature side heat supply unit that supplies heat to the low temperature heat medium in the low-temperature heat medium circuit 40. The low-temperature side on-board equipment 44 is, for example, a PCU, an inverter, a motor generator, a transaxle device, a control device for ADAS, and the like.

The PCU is a power control unit that performs power transformation and power distribution. The inverter is a power conversion unit that converts a direct current into an alternating current. The motor generator outputs driving force for traveling by receiving supply of electric power, and generates regenerative electric power at the time of deceleration or the like.

The transaxle device is a device that integrates a transmission, a final gear, and a differential gear. The control device for ADAS is a control device for an advanced driver assistance system. The heat medium passage in the low-temperature side on-board equipment 44 is formed in a cover that houses each of configuration devices, and is configured so that the exhaust heat of each of the equipment devices can be recovered and the equipment devices can be cooled by circulating the low temperature heat medium through the heat medium passage. Therefore, the low-temperature side on-board equipment 44 can also be considered an example of a temperature adjuster that includes the devices themselves as the temperature adjustment target.

The inlet port side of the heat medium passage in the low-temperature side on-board equipment 44 is connected to the discharge port side of the second low-temperature side pump 45. The second low-temperature side pump 45 is a heat medium pump that pumps the low temperature heat medium in the low-temperature heat medium circuit 40 to the inlet port side of the heat medium passage of the low-temperature side on-board equipment 44. The basic configuration of the second low-temperature side pump 45 is similar to that of the high-temperature side pump 21 and the first low-temperature side pump 41.

The other one of the heat medium outlet ports of the low-temperature side flow rate adjustment valve 42 is connected to the heat medium inlet port side of the outside air heat exchanger 46. The outside air heat exchanger 46 is arranged outside the cabin of the electric vehicle, and exchanges heat between the low temperature heat medium circulating through the low-temperature heat medium circuit 40 and the outside air OA outside the cabin.

A low-temperature side bypass flow path 47 is connected to the yet other one of the heat medium outlet ports of the low-temperature side flow rate adjustment valve 42. The low-temperature side bypass flow path 47 is connected so that the flow of the low temperature heat medium in the low-temperature heat medium circuit 40 bypasses the battery 43 and the low-temperature side on-board equipment 44.

As shown in FIG. 1, the heat medium outlet port side of the outside air heat exchanger 46 is connected to one of the inlet/outlet ports of a low-temperature side connection part 48 formed in the shape of a five-way joint. The other inlet/outlet ports of the low-temperature side connection part 48 is connected to the suction port side of the second low-temperature side pump 45. Yet other one of the inlet/outlet ports of the low-temperature side connection part 48 is connected to an end of the low-temperature side bypass flow path 47. The still yet other one of the inlet/outlet ports of the low-temperature side connection part 48 is connected to the outlet port side of the heat medium passage of the battery 43. The still yet other one of the inlet/outlet ports of the low-temperature side connection part 48 is connected to the suction port side of the first low-temperature side pump 41.

Therefore, in the low-temperature heat medium circuit 40, various circulation routes for the low temperature heat medium can be realized. For example, by controlling the operation of the low-temperature side flow rate adjustment valve 42, a circulation route can be configured in which the flow passing through the battery 43 and the flow passing through the low-temperature side bypass flow path 47 are connected in parallel with respect to the flow of the low temperature heat medium that has passed through the heat medium heat exchanger 31 and the chiller 16.

The low-temperature heat medium circuit 40 can provide (i) a circulation route using the first low-temperature side pump 41 and (ii) a circulation route using the second low-temperature side pump 45, each of which is configured as an independent route, by controlling the operation of the low-temperature side flow rate adjustment valve 42. For example, a route that circulates via the first low-temperature side pump 41, the heat medium heat exchanger 31, the chiller 16, and the battery 43, and a route that circulates via the second low-temperature side pump 45, the low-temperature side on-board equipment 44, and the outside air heat exchanger 46 can be configured as an independent route, respectively.

Next, the cabin air conditioning unit 50 that constitutes the thermal management system 1 is described with reference to FIG. 2. The cabin air conditioning unit 50 is a unit in the thermal management system 1 for blowing out the air W whose temperature has been adjusted by the refrigeration cycle 10 to an appropriate position in the vehicle cabin. The cabin air conditioning unit 50 is arranged inside an instrument panel at the front-most end of the vehicle cabin.

The cabin air conditioning unit 50 accommodates a blower 52, the inside evaporator 15, the heater core 23, and the like in an air passage formed inside the casing 51 that forms an outer shell of the unit. The casing 51 forms an air passage for the air W to be blown into the vehicle cabin. The casing 51 is molded from a resin (specifically, polypropylene) that has a certain degree of elasticity and is also excellent in strength.

As shown in FIG. 2, an inside/outside air switching device 53 is arranged on the most upstream side of the air flow in the casing 51. The inside/outside air switching device 53 selectively introduces the inside air (vehicle cabin air) or/and the outside air (outside vehicle air) into the casing 51.

The inside/outside air switching device 53 continuously adjusts the opening area sizes of (i) the inside air inlet port that introduces the inside air into the casing 51 and (ii) the outside air inlet port that introduces the outside air, by using an inside/outside air switching door, thereby changing the introduction ratio of the inside air intake volume and the outside air intake volume. The inside/outside air switching door is driven by an electric actuator for the inside/outside air switching door. Operation of the electric actuator is controlled by a control signal output from the control device 60.

The blower 52 is arranged on the air flow downstream side of the inside/outside air switching device 53. The blower 52 is configured as an electric blower in which a centrifugal multi-blade fan is driven by an electric motor. The blower 52 blows the air drawn in through the inside/outside air switching device 53 toward the vehicle cabin. The rotation speed (i.e., blowing capacity) of the blower 52 is controlled by a control voltage output from the control device 60.

On the downstream side of the air flow of the blower 52, the inside evaporator 15 and the heater core 23 are arranged in this written order with respect to the air flow. That is, the inside evaporator 15 is arranged upstream of the heater core 23 in the air flow direction.

A cold air bypass passage 55 is formed inside the casing 51. The cold air bypass passage 55 is an air passage that allows the air W that has passed through the inside evaporator 15 to bypass the heater core 23 and flow downstream.

An air mix door 54 is arranged downstream of the inside evaporator 15 in the air flow direction and upstream of the heater core 23 in the air flow direction. The air mix door 54 adjusts the ratio of the air volume passing through the heater core 23 to the air volume passing through the cold air bypass passage 55, out of the air W that has passed through the inside evaporator 15.

The air mix door 54 is driven by an electric actuator for driving the air mix door. The operation of the electric actuator is controlled by a control signal output from the control device 60.

A mixing space 56 is provided downstream of the heater core 23 in the air flow direction. In the mixing space 56, the air W heated by the heater core 23 and the air W that has passed through the cold air bypass passage 55 and has not been heated by the heater core 23 are mixed.

An opening hole is arranged at the most downstream portion of the air flow of the casing 51, through which the air (conditioned air) mixed in the mixing space 56 is blown out into the vehicle cabin. As the opening holes, a face opening hole, a foot opening hole, and a defroster opening hole (all not shown) are provided.

The face opening hole is an opening hole for blowing out the conditioned air toward an upper body of an occupant in the vehicle cabin. The foot opening hole is an opening hole for blowing out the conditioned air toward feet of the occupant. The defroster opening hole is an opening hole for blowing out the conditioned air toward an inner surface of window glass on a front side of the vehicle.

The face opening hole, the foot opening hole, and the defroster opening hole are respectively connected to a face blowing port, a foot blowing port, and a defroster blowing port (all not shown) provided in the vehicle cabin via ducts forming air passages.

Therefore, the temperature of the conditioned air mixed in the mixing space 56 is adjusted by the air mix door 54 adjusting the ratio of the air volume passing through the heater core 23 to the air volume passing through the cold air bypass passage 55. In such manner, the temperature of the air (i.e., conditioned air) blown into the vehicle cabin from each of the blowing ports is also adjusted.

Further, a face door, a foot door, and a defroster door (all not shown) are arranged upstream of the face opening hole, the foot opening hole, and the defroster opening hole, respectively, in the air flow direction. The face door adjusts an opening area size of the face opening hole. The foot door adjusts an opening area size of the foot opening hole. The defroster door adjusts an opening area size of the defroster opening hole.

The face door, the foot door, and the defroster door constitute a blowing mode switching device that switches the blowing port from which the conditioned air is blown. The face door, the foot door, and the defroster door are coupled to a blowing port mode door driving electric actuator via a link mechanism or the like, and are rotationally operated in conjunction with each other. Operation of the electric actuator is controlled by a control signal output from the control device 60.

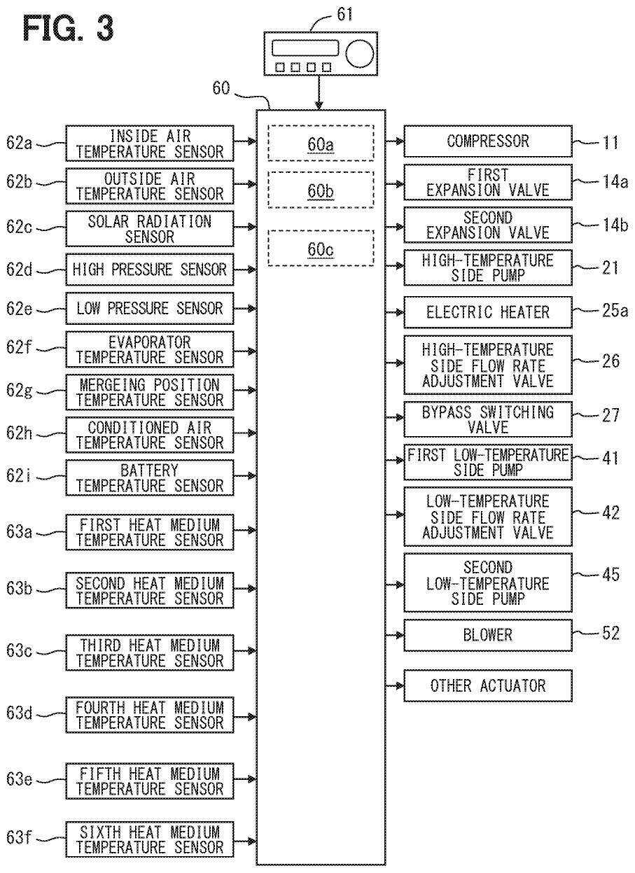

Next, a control system of the thermal management system 1 according to the first embodiment is described with reference to FIG. 3. The control device 60 includes a known microcomputer including CPU, ROM, RAM and the like, and peripheral circuits.

The control device 60 performs various calculations and processes based on the control programs stored in the ROM, and controls the operation of various control target devices connected to its output side. The control device 60 corresponds to an example of a control unit.

The control target device includes the compressor 11, the first expansion valve 14a, the second expansion valve 14b, the high-temperature side pump 21, the electric heater 25a, the high-temperature side flow rate adjustment valve 26, the bypass switching valve 27, the first low-temperature side pump 41, the low-temperature side flow rate adjustment valve 42, the second low-temperature side pump 45, the blower 52, and the like.

As shown in FIG. 3, a group of sensors for air-conditioning control is connected to the input side of the control device 60. The group of sensors for air-conditioning control includes an inside air temperature sensor 62a, an outside air temperature sensor 62b, a solar radiation sensor 62c, a high pressure sensor 62d, a low pressure sensor 62e, an evaporator temperature sensor 62f, a merging portion temperature sensor 62g, a conditioned air temperature sensor 62h, and a battery temperature sensor 62i. The control device 60 receives detection signals from the group of sensors for air-conditioning control.

The inside air temperature sensor 62a is an inside air temperature detection unit that detects a vehicle cabin temperature (an inside air temperature) Tr. The outside air temperature sensor 62b is an outside air temperature detection unit that detects an ambient air temperature (an outside air temperature) Tam. The solar radiation sensor 62c is a solar radiation amount detection unit that detects a solar radiation amount As irradiated into the vehicle cabin.

The high pressure sensor 62d is a refrigerant pressure detection unit that detects a refrigerant pressure in a refrigerant flow path from the discharge port side of the compressor 11 to the inlet port side of the first expansion valve 14a or the second expansion valve 14b. In the example of the present embodiment, the high pressure sensor 62d is arranged on the outlet port side of the refrigerant passage of the heat medium refrigerant heat exchanger 12, and detects the pressure of the refrigerant flowing out from the refrigerant passage of the heat medium refrigerant heat exchanger 12.

The low pressure sensor 62e is a refrigerant pressure detection unit that detects the refrigerant pressure in the refrigerant flow path from the outlet port side of the first expansion valve 14a or the second expansion valve 14b to the suction port side of the compressor 11. In the example of the present embodiment, the low pressure sensor 62e is arranged on the outlet port side of the refrigerant passage of the chiller 16 and detects the pressure of the refrigerant flowing out from the refrigerant passage of the chiller 16.

The evaporator temperature sensor 62f is an evaporator temperature detection unit that detects the refrigerant evaporation temperature (evaporator temperature) Tefin in the inside evaporator 15. The merging portion temperature sensor 62g is a refrigerant temperature detection unit that detects the refrigerant temperature at the refrigerant merging portion 13b of the refrigeration cycle 10. The conditioned air temperature sensor 62h is a conditioned air temperature detection unit that detects a blown air temperature TAV, which is the temperature of the air blown from the cabin air conditioning unit 50 into the vehicle cabin.

The battery temperature sensor 62i is a battery temperature detection unit that detects a battery temperature TB (that is, the temperature of the battery 43). The battery temperature sensor 62i includes multiple temperature sensors, and detects the temperatures of multiple positions of the battery 43. Therefore, the control device 60 can also detect the temperature difference between the various parts of the battery 43. The battery temperature TB is an average value of the detected values of the plurality of temperature sensors.

Multiple heat medium temperature sensors are connected to the input side of the control device 60 in order to detect the temperatures of (a) the high temperature heat medium in the high-temperature heat medium circuit 20 and (b) the low temperature heat medium in the low-temperature heat medium circuit 40, respectively. The plurality of heat medium temperature sensors include a first heat medium temperature sensor 63a to a sixth heat medium temperature sensor 63f.

The first heat medium temperature sensor 63a is a temperature detection unit that detects the temperature of the high temperature heat medium flowing through the heat medium passage of the heat medium refrigerant heat exchanger 12, and is arranged, for example, at an outlet port portion of the heat medium passage of the heat medium refrigerant heat exchanger 12. The second heat medium temperature sensor 63b is a temperature detection unit that detects the temperature of the high temperature heat medium passing through the heater core 23, and is arranged at the outlet port portion of the heater core 23, for example.

The third heat medium temperature sensor 63c is a temperature detection unit for detecting the temperature of the high-temperature side on-board equipment 25, and is arranged at the outlet port portion of the high-temperature side on-board equipment 25, for example. That is, the third heat medium temperature sensor 63c may directly detect the temperature of the high-temperature side on-board equipment 25, or may detect the temperature of the high temperature heat medium in the vicinity of the high-temperature side on-board equipment 25.

The fourth heat medium temperature sensor 63d is a temperature detection unit that detects the temperature of the low temperature heat medium flowing through the heat medium passage of the chiller 16, and is arranged at the outlet port portion of the heat medium passage of the chiller 16, for example.

The fifth heat medium temperature sensor 63e is a temperature detection unit that detects the temperature of the low temperature heat medium flowing through the heat medium passage of the low-temperature side on-board equipment 44, and is arranged, for example, at the outlet port portion of the heat medium passage of the low-temperature side on-board equipment 44. That is, the fifth heat medium temperature sensor 63e may directly detect the temperature of the low-temperature side on-board equipment 44, or may detect the temperature of the low temperature heat medium in the vicinity of the low-temperature side on-board equipment 44.

The sixth heat medium temperature sensor 63f is a temperature detection unit that detects the temperature of the low temperature heat medium flowing through the low temperature heat medium passage of the heat medium heat exchanger 31, and is arranged, for example, at the outlet port portion of the low temperature heat medium passage of the heat medium heat exchanger 31.

The thermal management system 1 switches the flow of the heat medium in the high-temperature heat medium circuit 20 and the low-temperature heat medium circuit 40 by referring to the detection results of the first to sixth heat medium temperature sensors 63a to 63f. As a result, the thermal management system 1 can manage heat in the vehicle using a high temperature heat medium and a low temperature heat medium, and can achieve heat transfer via the heat transfer unit 30.

The input side of the control device 60 is connected to an operation panel 61 arranged near the instrument panel at the front part of the vehicle cabin. The operation panel 61 has multiple operation switches arranged thereon. Therefore, operation signals from these multiple operation switches are input to the control device 60. The various operation switches on the operation panel 61 include an auto switch, a cooling switch, an air volume setting switch, a temperature setting switch, and the like.

The auto switch is operated to set or cancel the automatic control operation of the thermal management system 1. The cooling switch is operated when cooling of the vehicle cabin is requested. The air volume setting switch is operated when manually setting the air volume of the blower 52. The temperature setting switch is operated when a target temperature Tset of the vehicle cabin is set.

In the control device 60, a control unit that controls various control target devices connected to output side thereof is integrally configured as a part of the control device 60, which includes the configurations (hardware and software) that control the operation of the respective control target devices constituting the respective control units that control the operation of such control target devices. For example, in the control device 60, a configuration that executes pre-control when starting operation of the refrigeration cycle 10 in a low temperature environment (for example, an environment where the outside air temperature is −20 degrees of Celsius or lower) is a pre-control execution unit 60a. The pre-control execution unit 60a controls the operation of each of the configuration devices based on the detection results from the various detection units, in relation to the pre-control in step S20 described in the following.

In the control device 60, a heating priority control unit 60b is a configuration that executes heating priority control that prioritizes heating of air in the heater core 23 when operating in the heating mode. The heating priority control unit 60b controls the operation of the compressor 11, the electric heater 25a, and the high-temperature side flow rate adjustment valve 26, giving priority to improving the air heating capacity.

A temperature adjustment priority control unit 60c is a configuration in the control device 60 that executes temperature adjustment priority control that prioritizes temperature adjustment of the battery 43 and/or the low-temperature side on-board equipment 44 when operating in the heating mode. The temperature adjustment priority control unit 60c controls the operation of the compressor 11, the electric heater 25a, and the high-temperature side flow rate adjustment valve 26, giving priority to improving the temperature adjustment capacity regarding the battery 43, and the like over the air heating capacity.

Next, the operation of the thermal management system 1 is described. As described above, in the thermal management system 1 according to the first embodiment, the operation mode can be switched appropriately from among the multiple operation modes. The switching between the operation modes is performed by executing a control program stored in advance in the control device 60.

More specifically, the control program calculates a target blown air temperature TAO of the air to be blown into the vehicle cabin based on the detection signals detected by the group of sensors for air-conditioning control and the operation signals output from the operation panel 61. Then, the operation mode for the air-conditioning the vehicle cabin is switched based on the target blown air temperature TAO and the detection signals.

Whether or not temperature adjustment (cooling or heating) of the battery 43 and the low-temperature side on-board equipment 44 is required is determined based on the heat medium temperatures detected by the first heat medium temperature sensor 63a to the sixth heat medium temperature sensor 63f and the battery temperature TB detected by the battery temperature sensor 62i. For example, when the battery temperature TB comes out of a predetermined temperature range, it is determined that adjustment of the temperature of the battery 43 is required.

Therefore, the multiple operation modes in the thermal management system 1 are configured by a combination of (i) operation modes related to the air conditioning of the vehicle cabin and (ii) operation modes related to the temperature adjustment of the configuration devices (battery 43, low-temperature side on-board equipment 44, and the like). The multiple operation modes include the heating mode, the cooling mode, and the dehumidifying and heating mode.

The heating mode is an operation mode in which air to be blown into the vehicle cabin is heated by the heater core 23 and supplied to the vehicle cabin. The cooling mode is an operation mode in which air is cooled by the inside evaporator 15 and supplied to the vehicle cabin. The dehumidifying and heating mode is an operation mode in which air dehumidified by the inside evaporator 15 is heated by the heater core 23 and supplied to the vehicle cabin.

In these operation modes, the thermal management system 1 can perform the temperature adjustment of the battery 43 and the like.

The control device 60 starts controlling the operation of each of the configuration devices of the refrigeration cycle 10 when the operation of the refrigeration cycle 10 is started. Specifically, as to the configuration of the refrigeration cycle 10, the operation of (i) the compressor 11, and (ii) at least one of the first expansion valve 14a and the second expansion valve 14b is controlled.

The refrigerant discharge capacity of the compressor 11 is determined so that the refrigerant discharge capacity based on the operation mode is realized. The opening degrees of the refrigerant passages in the first expansion valve 14a and the second expansion valve 14b are individually determined based on the operation mode.

The following describes the operation control when, from among the above-mentioned operation modes, the heating mode is performed.

The refrigerant discharge capacity of the compressor 11 in the heating mode is determined so that the blown air temperature TAV detected by the conditioned air temperature sensor 62h approaches the target blown air temperature TAO. In the heating mode, the opening degree of the refrigerant passage of the first expansion valve 14a is set to a full closed state, and the opening degree of the refrigerant passage of the second expansion valve 14b is adjusted to a predetermined throttle opening degree.

In the refrigeration cycle 10 in the heating mode, the refrigerant circulates to flow through the compressor 11, the heat medium refrigerant heat exchanger 12, the refrigerant branch portion 13a, the second expansion valve 14b, the chiller 16, the refrigerant merging portion 13b, and the compressor 11 in the written order. In the refrigeration cycle 10 in the heating mode, the heat medium refrigerant heat exchanger 12 functions as a radiator, and the chiller 16 functions as an evaporator.

In the heating mode, for the high-temperature heat medium circuit 20, the operations of the high-temperature side pump 21, the electric heater 25a, and the high-temperature side flow rate adjustment valve 26 are controlled. The control device 60 operates the high-temperature side pump 21 for achieving a predetermined pumping capacity. The heat generation amount of the electric heater 25a is determined based on, for example, the outside air temperature Tam detected by the outside air temperature sensor 62b, the heat medium temperatures detected by the first heat medium temperature sensor 63a to the sixth heat medium temperature sensor 63f, and the like.

The control device 60 controls the high-temperature side flow rate adjustment valve 26 in the heating mode, so as to (i) interconnect the inlet/outlet port on the heat medium heat exchanger 31 side, the inlet/outlet port on an electric heater 25a side, and the inlet/outlet port on the heater core 23 side, and (ii) close the inlet/outlet port on the radiator 24 side.

In the high-temperature heat medium circuit 20 in the heating mode, the flow of the high temperature heat medium circulating through the heat medium refrigerant heat exchanger 12 is configured such that a route via the heater core 23 and a route via the heat medium heat exchanger 31 are connected in parallel.

In the heating mode, the low temperature heat medium is circulated in the low-temperature heat medium circuit 40. Therefore, the control device 60 controls the operation of the first low-temperature side pump 41 for achieving the pumping capacity set for the heating mode. The control device 60 controls the operation of the low-temperature side flow rate adjustment valve 42 (i) to connect the inlet/outlet port on a chiller 16 side with the inlet/outlet port on a battery 43 side, and (ii) to fully close the inlet/outlet port on an outside air heat exchanger 46 side, the inlet/outlet port on a low-temperature side on-board equipment 44 side, and the inlet/outlet port on the low-temperature side bypass flow path 47 side.

In the low-temperature heat medium circuit 40 in the heating mode, the low temperature heat medium circulates to flow through the first low-temperature side pump 41, the heat medium heat exchanger 31, the chiller 16, the low-temperature side flow rate adjustment valve 42, the battery 43, and the first low-temperature side pump 41 in the written order. Therefore, the temperature of the battery 43 is adjusted in parallel with the heating of the vehicle cabin.

When temperature adjustment of the battery 43 is not required, the control device 60 controls the operation of the low-temperature side flow rate adjustment valve 42 to set a full close state of the inlet/outlet port on the battery 43 side.

Regarding the circulation route of the low temperature heat medium in the heating mode, by controlling the operation of the low-temperature side flow rate adjustment valve 42, a variety of routes can be adopted as the circulation route of the heat medium after flowing through the first low-temperature side pump 41, the heat medium heat exchanger 31, and the chiller 16. By adjusting the operation of the low-temperature side flow rate adjustment valve 42 so that the low temperature heat medium flows through the radiator 24, the heat of the outside air can be absorbed by the low temperature heat medium in a predetermined case. By controlling the operation of the low-temperature side flow rate adjustment valve 42 and switching the heat medium to flow through the low-temperature side bypass flow path 47, it is possible to realize a heating mode in which the temperature of the configuration devices is not adjusted.

As described above, in the thermal management system 1 in the heating mode, the low temperature heat medium circulates through the heat medium heat exchanger 31, the battery 43, and the chiller 16. Therefore, the thermal management system 1 in the heating mode can absorb heat of the low temperature heat medium heated by the exhaust heat of the battery 43 and the heat transferred in the heat medium heat exchanger 31 into the low pressure refrigerant in the chiller 16.

In the thermal management system 1 in the heating mode, the chiller 16 functions as a heat absorber and the heat medium refrigerant heat exchanger 12 functions as a heat radiator, thereby heat absorbed by the chiller 16 is collected and is used to heat the high temperature heat medium in the heat medium refrigerant heat exchanger 12.

In the thermal management system 1 in the heating mode, the heater core 23 and the heat medium heat exchanger 31 are connected in parallel to the flow of the high temperature heat medium that has flowed through the heat medium refrigerant heat exchanger 12. Therefore, in the thermal management system 1 in the heating mode, a portion of the high temperature heat medium heated in the heat medium refrigerant heat exchanger 12 can be distributed to the heater core 23, and the remainder can be distributed to the heat transfer unit 30, thereby achieving the desired heating capacity.

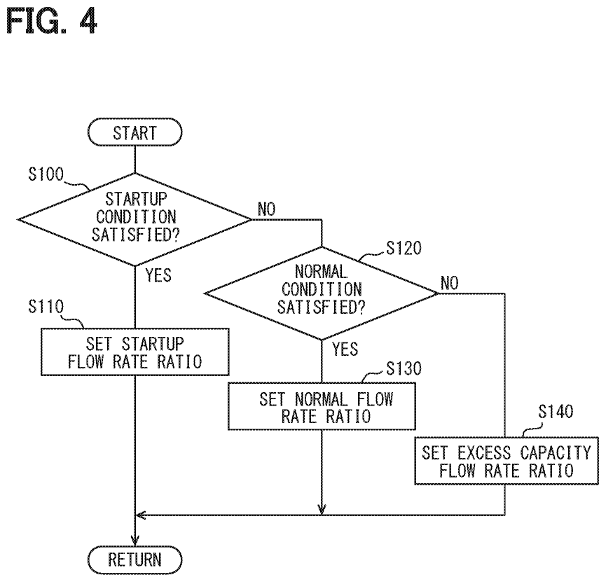

The operation of the high-temperature side flow rate adjustment valve 26 will now be described in detail. The flowchart in FIG. 4 shows a control program executed by the control device 60 to control the operation of the high-temperature side flow rate adjustment valve 26. The control program is executed when operation in the heating mode is required, or when temperature adjustment of the battery 43, and the like is required, in a situation in which operation of the compressor 11 is required.

First, in step S100, it is determined whether or not a startup condition is satisfied. The startup condition is a condition that is satisfied mainly when the thermal management system 1 is started up. In the example of the present embodiment, the startup condition is a condition that is satisfied when the density of the refrigerant in the refrigeration cycle 10 is in a low range. Specifically, when it is determined that the refrigerant pressure detected by the high pressure sensor 62d (hereinafter referred to as the high pressure side pressure of the refrigeration cycle 10) is lower than a first threshold value (e.g., 2.0 MPa), it is determined that the startup condition is satisfied based on an estimation that the density of the refrigerant in the refrigeration cycle 10 is low.

When it is determined in step S100 that the startup condition is satisfied, the process proceeds to step S110, where the high-temperature side flow rate adjustment valve 26 is controlled so that the heat transfer unit flow rate ratio (i.e., the ratio of (i) the flow rate of the high temperature heat medium in the heat medium heat exchanger 31 to (ii) the flow rate of the high temperature heat medium circulating in the high-temperature heat medium circuit 20) becomes the startup flow rate ratio (in other words, the maximum ratio). In the example of the present embodiment, the startup flow rate ratio is 100%. As a result, the high temperature heat medium that has been discharged from the high-temperature side pump 21 and circulated through the heat medium refrigerant heat exchanger 12 entirely flows through the heat medium heat exchanger 31.

As a result, in the heat medium heat exchanger 31, heat exchange is performed between (i) the high temperature heat medium flowing through the high temperature heat medium passage and (ii) the low temperature heat medium in the low temperature heat medium passage, and the heat possessed by the high temperature heat medium is transferred to the low temperature heat medium, thereby heating the low temperature heat medium.

Since the low temperature heat medium heated by the heat of the high temperature heat medium exchanges heat with the refrigerant in the refrigerant passage of the chiller 16, the heat of the high temperature heat medium is transferred to the refrigerant of the refrigeration cycle 10 via the low temperature heat medium. As a result, the refrigeration cycle 10 is enabled to exhibit the desired capacity, due to rise of the temperature of the refrigerant in the refrigeration cycle 10 by the heat transferred via the low temperature heat medium from the high temperature heat medium, causing increase of (i) the density of the refrigerant in the refrigeration cycle 10 and (ii) the compression workload of the compressor 11.

That is, the refrigeration cycle 10 is operated with priority given to increasing the density of the refrigerant in the refrigeration cycle 10 and exerting the heating capacity. Thus, it is possible to achieve a desired heating capacity as quickly as possible in a low temperature environment, for example, in a condition where the outside air temperature is −20 degrees of Celsius or lower.

In other words, in a low temperature environment where the outside air temperature is −20 degrees of Celsius or lower, when the refrigeration cycle 10 of the thermal management system 1 starts operating, both of the refrigerant temperature and the refrigerant density of the refrigeration cycle 10 lower due to the influence of the outside air, thereby the compression workload of the compressor 11 lowers and the refrigeration cycle 10 cannot exhibit its capacity.

Considering the environmental conditions such as outside air temperature, the operating mode performed by the thermal management system 1 in a low temperature environment is expected to be the heating mode, in which the heating capacity of the heating mode lowers when the capacity of the refrigeration cycle 10 cannot be exhibited. That is, when operation in the heating mode is started, a heating capacity lowered state continues until the refrigerant temperature of the refrigeration cycle 10 rises up, thereby causing a state in which the comfort of the occupants is impaired.

In this regard, in the present embodiment, when it is determined in step S100 that the startup condition is satisfied, the density of the refrigerant in the refrigeration cycle 10 is increased by controlling the high-temperature side flow rate adjustment valve 26 in step S110 so that the heat transfer unit flow rate ratio becomes the startup flow rate ratio. Therefore, when the refrigeration cycle 10 starts operating in a low temperature environment, a capacity-lowered period during which the capacity of the refrigeration cycle 10 lowers due to low outside air temperature can be shortened as much as possible.

When it is determined in step S100 that the startup condition is not satisfied, the process proceeds to step S120, where it is determined whether or not a normal condition is satisfied. The normal condition is a condition that is satisfied mainly during normal operation of the thermal management system 1. In the example of the present embodiment, the normal condition is a condition that is satisfied when the density of the refrigerant in the refrigeration cycle 10 is in an intermediate range. Specifically, when it is determined that the high pressure side pressure of the refrigeration cycle 10 is higher than a first threshold value (e.g., 2.0 MPa) and lower than a second threshold value (e.g., 2.5 MPa), it is estimated that the density of the refrigerant of the refrigeration cycle 10 is in an intermediate range, and it is determined that the startup condition is satisfied. The second threshold value is a value greater than the first threshold value.

When it is determined in step S120 that the normal condition is satisfied, the process proceeds to step S130, where the high-temperature side flow rate adjustment valve 26 is controlled so that the heat transfer unit flow rate ratio becomes the normal flow rate ratio (in other words, an intermediate ratio).

In the example of the present embodiment, the normal flow rate ratio is greater than 0% and less than 100%. For example, the normal flow rate ratio is determined as a greater ratio as the pressure of the high pressure refrigerant in the refrigeration cycle 10 lowers. In such manner, the flow rate of the high temperature heat medium is appropriately distributed between the heat medium heat exchanger 31 and the heater core 23, making it possible to appropriately maintain the refrigerant density and heating capacity of the refrigeration cycle 10.

When it is determined in step S120 that the normal condition is not satisfied, it is estimated that the refrigerant density of the refrigeration cycle 10 is in a high range, and the process proceeds to step S140, where the high-temperature side flow rate adjustment valve 26 is controlled so that the heat transfer unit flow rate ratio becomes an excess capacity flow rate ratio (in other words, the minimum rate). In the example of the present embodiment, the excess capacity flow rate ratio is 0%. As a result, the high temperature heat medium does not flow into the heat medium heat exchanger 31, and the density of the refrigerant in the refrigeration cycle 10 is prevented from becoming excessively high.

That is, the refrigeration cycle 10 is operated with priority given to stabilizing the state of the cycle when the capacity of the refrigeration cycle 10 is excessive.

When (i) the heat transfer unit flow rate ratio is greater than 0%, i.e., when the high temperature heat medium discharged from the high-temperature side pump 21 and circulating through the heat medium refrigerant heat exchanger 12 flows through the heat medium heat exchanger 31, and (ii) it is predicted that the travel load enters a high load range, it is preferable to make the heat transfer unit flow rate ratio lower than a ratio of when it is predicted that the travel load does not enter the high load range. When the travel load becomes high, the amount of heat generated by the low-temperature side on-board equipment 44 increases. Therefore, by lowering the heat transfer unit flow rate ratio, excessive heat transfer from the high-temperature heat medium circuit 20 to the low-temperature heat medium circuit 40 can be suppressed, and ultimately the power consumption of the compressor 11 is reducible.

The travel load can be predicted based on map information used in vehicle navigation systems and the like. For example, when traveling on an uphill road or an expressway, the travel load is expected to be high.

The travel load can be predicted based on accelerator opening information of the vehicle. For example, when the accelerator opening degree of the vehicle is large, the travel load is predicted to be high.

The prediction can also be made based on temperature information of the battery 43 and powertrain devices. The powertrain devices are electrical devices, such as inverters and motor generators, that generate driving force for the travel of the vehicle. For example, when the temperature of the battery 43 or the powertrain devices is high, it is predicted that the travel load is high.

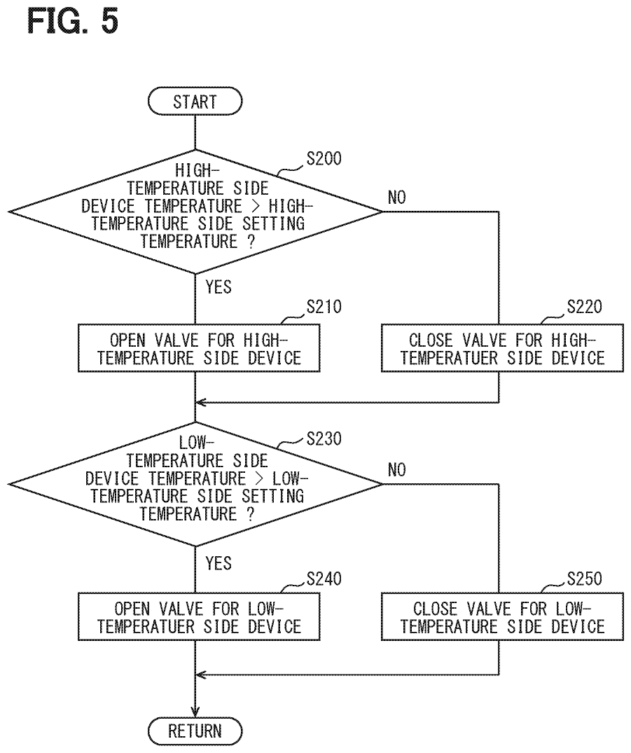

Next, details of the operation of the bypass switching valve 27 and the low-temperature side flow rate adjustment valve 42 is described in detail. The flowchart in FIG. 5 shows a control program executed by the control device 60 to control the operation of the bypass switching valve 27 and the low-temperature side flow rate adjustment valve 42.

In step S200, it is determined whether the temperature of the high-temperature side on-board equipment 25 detected by the third heat medium temperature sensor 63c (hereinafter referred to as a high-temperature side equipment temperature) is higher than a high-temperature side set temperature. The high-temperature side set temperature is a predetermined temperature that is set in advance.

When it is determined in step S200 that the high-temperature side equipment temperature is higher than the high-temperature side set temperature, the process proceeds to step S210, where the bypass switching valve 27 opens the heat medium outlet port on a high-temperature side on-board equipment 25 side, and the process proceeds to step S230. In such manner, the high temperature heat medium discharged from the high-temperature side pump 21 and circulating through the heat medium refrigerant heat exchanger 12 flows through the high-temperature side on-board equipment 25, thereby high temperature heat medium is heated during such time.

When it is determined in step S200 that the high-temperature side equipment temperature is not higher than the high-temperature side set temperature, the process proceeds to step S220, where the bypass switching valve 27 closes the heat medium outlet port on the high-temperature side on-board equipment 25 side, and the process proceeds to step S230. In such manner, the flow of the high temperature heat medium discharged from the high-temperature side pump 21 and flowing through the heat medium refrigerant heat exchanger 12 bypasses the high-temperature side on-board equipment 25.

According to steps S200 to S220, the flow of the high temperature heat medium to the high-temperature side on-board equipment 25 can be started only after the high-temperature side equipment temperature has become sufficiently high, so that the high-temperature side on-board equipment 25 can appropriately heat the high temperature heat medium, thereby improving the heating capacity.

In step S230, it is determined whether the temperature of the low-temperature side on-board equipment 44 detected by the fifth heat medium temperature sensor 63e (hereinafter referred to as a low-temperature side equipment temperature) is higher than a low-temperature side set temperature. The low-temperature side set temperature is a predetermined temperature that is set in advance.

When it is determined in step S230 that the low-temperature side equipment temperature is higher than the low-temperature side set temperature, the process proceeds to step S240, where the low-temperature side flow rate adjustment valve 42 opens the heat medium inlet port on the low-temperature side on-board equipment 44 side, and the process proceeds to step S230. In such manner, the low temperature heat medium circulates between the chiller 16 and the low-temperature side on-board equipment 44, and heat of the low temperature heat medium heated by the low-temperature side on-board equipment 44 is absorbed by the refrigerant flowing through the chiller 16.

When it is determined in step S230 that the low-temperature side equipment temperature is not higher than the low-temperature side set temperature, the process proceeds to step S250, where the low-temperature side flow rate adjustment valve 42 closes the heat medium inlet port on the low-temperature side on-board equipment 44 side. In such manner, the low temperature heat medium does not circulate between the chiller 16 and the low-temperature side on-board equipment 44.

According to steps S230 to S250, the flow of the low temperature heat medium to the low-temperature side on-board equipment 44 is started only after the low-temperature side equipment temperature has become sufficiently high, so that the low-temperature side on-board equipment 44 can appropriately heat the low temperature heat medium, thereby improving the heating capacity.

In the present embodiment, as explained in steps S100 to S140, the control device 60 controls the high-temperature side flow rate adjustment valve 26 so that the lower the density of the refrigerant is, the higher the heat transfer unit flow rate ratio becomes.

In such manner, the heat possessed by the high temperature heat medium is transferred to the low temperature heat medium in the heat transfer unit 30, thereby heating the low temperature heat medium, and the heat can be absorbed by the refrigerant in the refrigeration cycle 10 from the low temperature heat medium in the chiller 16, thereby raising the temperature of the refrigerant. In such manner, increase of the density of the refrigerant in the refrigeration cycle 10 is caused, thereby (a) making it easier to obtain the compression workload for the compressor 11 when the refrigeration cycle 10 starts operating, and (b) making it easier for the refrigeration cycle 10 to exhibit the desired capacity.

Further, the lower the density of the refrigerant is, the higher the heat transfer unit flow rate ratio is made, thereby heat can be appropriately transferred from the high-temperature heat medium circuit 20 to the low-temperature heat medium circuit 40.

That is, while it is possible to prioritize heat transfer from the high temperature heat medium to the low temperature heat medium, for obtaining the capacity of the refrigeration cycle 10 when the priority of heat transfer from the high temperature heat medium to the low temperature heat medium is high, such as in a low temperature environment, it is also possible to prevent the situation of (i) causing the unstable state of the cycle due to the excessive rise of the refrigerant pressure, or (ii) causing the insufficient supply of heat to the heater core 23 in the high-temperature heat medium circuit 20 when the priority of heat transfer from the high temperature heat medium to the low temperature heat medium is low.

The control device 60 controls the high-temperature side flow rate adjustment valve 26 so that (a) when the density of the refrigerant is in a range lower than the intermediate range, the heat transfer unit flow rate ratio becomes the maximum ratio, (b) when the density of the refrigerant, the amount of heat possessed by the high temperature heat medium, or the amount of heat possessed by the low temperature heat medium is in the intermediate range, the heat transfer unit flow rate ratio becomes the intermediate ratio, and (c) when the density of the refrigerant, the heat amount possessed by the high temperature heat medium, or the heat amount possessed by the low temperature heat medium is in a range higher than the intermediate range, the heat transfer unit flow rate ratio becomes the minimum ratio.

In such manner, when the priority of heat transfer from the high temperature heat medium to the low temperature heat medium is high, it is possible to highly prioritize the heat transfer from the high temperature heat medium to the low temperature heat medium, thereby, with high priority, exhibiting the capacity of the refrigeration cycle 10, and when the priority of heat transfer from the high temperature heat medium to the low temperature heat medium is low, it is possible to prevent the situation of (a) causing the unstable state of the cycle due to excessive rise of the refrigerant pressure, or (b) causing an insufficient supply of heat to the heater core 23 in the high-temperature heat medium circuit 20.

As explained in steps S110 and S140, the control device 60 sets the maximum heat transfer unit flow rate ratio to 100% and the minimum heat transfer unit flow rate ratio to 0%. In such manner, when the priority of heat transfer from the high temperature heat medium to the low temperature heat medium is high, the transfer of heat from the high temperature heat medium to the low temperature heat medium is given the highest priority, thereby giving the highest priority to obtain the capacity of the refrigeration cycle 10, and when the priority of heat transfer from the high temperature heat medium to the low temperature heat medium is low, it is possible, as much as possible, to prevent the situation of (a) causing the unstable state of the cycle due to an excessive rise of the pressure of the low pressure refrigerant, or (b) causing an insufficient supply of heat to the heater core 23 in the high-temperature heat medium circuit 20.

As described in step S130, the control device 60 raises the intermediate ratio as the density of the refrigerant lowers. In such manner, it is possible to appropriately transfer heat from the high-temperature heat medium circuit to the low-temperature heat medium circuit in accordance with the density of the refrigerant when the priority of heat transfer from the high temperature heat medium to the low temperature heat medium is in an intermediate range.

As explained in steps S100 and S120, the control device 60 estimates the density of the refrigerant based on the pressure of the refrigerant after discharge from the compressor 11 and before decompression by the second expansion valve 14b. In such manner, the density of the refrigerant is determined simply and appropriately based on the pressure of the high pressure side refrigerant in the refrigeration cycle 10, thereby heat transfer from the high-temperature heat medium circuit 20 to the low-temperature heat medium circuit 40 is appropriately performable.

In the present embodiment, when the travel load is predicted to enter the high load range, the control device 60 controls the high-temperature side flow rate adjustment valve 26 so that the heat transfer unit flow rate ratio becomes lower than the one when the travel load is predicted not to enter the high load range. In such manner, it is possible to prevent an excessive heat transfer from the high-temperature heat medium circuit 20 to the low-temperature heat medium circuit 40 when the travel load becomes high and the heat generation amount of the low-temperature side on-board equipment 44 increases, thereby ultimately reducing the power consumption of the compressor 11.

In the present embodiment, as explained in steps S200 to S220, the control device 60 controls the bypass switching valve 27 so that when the temperature of the high-temperature side on-board equipment 25 is lower than a predetermined temperature, no high temperature heat medium flows to the high-temperature side on-board equipment 25, and when the temperature of the high-temperature side on-board equipment 25 is higher than the predetermined temperature, high temperature heat medium flows to the high-temperature side on-board equipment 25. According to the above, the flow of the high temperature heat medium to the high-temperature side on-board equipment 25 begins only after the temperature of the high-temperature side on-board equipment 25 has become sufficiently high, thereby enabling appropriate heating of the high temperature heat medium by the high-temperature side on-board equipment 25, and improving the heating capacity.

In the present embodiment, as explained in steps S230 to S250, the control device 60 controls the low-temperature side flow rate adjustment valve 42 so that when the temperature of the low-temperature side on-board equipment 44 is lower than a predetermined temperature, no low temperature heat medium flows to the low-temperature side on-board equipment 44, and when the temperature of the low-temperature side on-board equipment 44 is higher than the predetermined temperature, the low temperature heat medium flows to the low-temperature side on-board equipment 44. In such manner, the flow of the low temperature heat medium to the low-temperature side on-board equipment 44 begins only after the temperature of the low-temperature side on-board equipment 44 has risen sufficiently, thereby appropriately heating the low temperature heat medium by the low-temperature side on-board equipment 44, and improving the heating capacity.

### Second Embodiment

In the first embodiment described above, as shown in the flowchart of FIG. 4, the operation of the high-temperature side flow rate adjustment valve 26 is controlled based on the high pressure side pressure of the refrigeration cycle 10 (i.e., the refrigerant pressure detected by the high pressure sensor 62d). However, in the present embodiment, the operation of a high-temperature side flow rate adjustment valve 26 is controlled based on the refrigerant pressure detected by a low pressure sensor 62e (hereinafter referred to as the low pressure side pressure of a refrigeration cycle 10).

That is, in step S100, when it is determined that the low pressure side pressure of the refrigeration cycle 10 is lower than a first threshold value (e.g., 0.2 MPa), it is estimated that the density of the refrigerant in the refrigeration cycle 10 is low, and it is determined that a startup condition is satisfied.

In step S120, when it is determined that the low pressure side pressure of the refrigeration cycle 10 is higher than the first threshold value (e.g., 0.2 MPa) and lower than a second threshold value (e.g., 0.6 MPa), it is estimated that the density of the refrigerant in the refrigeration cycle 10 is approximately medium, and it is therefore determined that a normal condition is satisfied.

In the present embodiment, a control device 60 estimates the density of the refrigerant based on the pressure of the refrigerant after it has been decompressed by a second expansion valve 14b and before it is drawn into a compressor 11. In such manner, the density of the refrigerant is determinable simply and appropriately based on the pressure of the low pressure side refrigerant in the refrigeration cycle 10, thereby enabling appropriate transfer of heat from a high-temperature heat medium circuit 20 to a low-temperature heat medium circuit 40.

In the present embodiment, the same effects as those of the first embodiment are achievable.

### Third Embodiment

In the first and second embodiments described above, the operation of the high-temperature side flow rate adjustment valve 26 is controlled based on the density of the refrigerant in the refrigeration cycle 10 according to the flowchart of FIG. 4. However, in the present embodiment, the operation of a high-temperature side flow rate adjustment valve 26 is controlled based on the amount of heat possessed by the high temperature heat medium. In other words, in the first embodiment, the startup condition and the normal condition are, respectively, a condition related to the density of the refrigerant. However, in the present embodiment, a startup condition and a normal condition are, respectively, a condition related to the amount of heat possessed by the high temperature heat medium.

That is, in step S100, when it is determined that the temperature of the high temperature heat medium (hereinafter referred to as a high temperature heat medium temperature) detected by a first heat medium temperature sensor 63a is lower than a first threshold value (e.g., 70 degrees of Celsius), it is estimated that the high temperature heat medium has a small amount of heat, and therefore it is determined that the startup condition is satisfied.

In step S120, when it is determined that the high temperature heat medium temperature is higher than the first threshold value (e.g., 70 degrees of Celsius) and lower than a second threshold value (e.g., 90 degrees of Celsius), it is estimated that the amount of heat possessed by the high temperature heat medium is approximately intermediate, and therefore it is determined that the normal condition is satisfied.

In the present embodiment, a control device 60 controls a high-temperature side flow rate adjustment valve 26 so that the smaller the amount of heat possessed by the high temperature heat medium is, the greater the heat transfer unit flow rate ratio is made.

According to the above, similar to the first embodiment described above, while it is possible to prioritize the heat transfer from the high temperature heat medium to the low temperature heat medium and to obtain the capacity of a refrigeration cycle 10 when the priority of heat transfer from the high temperature heat medium to the low temperature heat medium is high, such as in a low temperature environment, it is also possible to prevent the situation of (a) causing the unstable state of the cycle due to an excessive rise in the refrigerant pressure or (b) causing an insufficient supply of heat to the heater core 23 in the high-temperature heat medium circuit 20 when the priority of heat transfer from the high temperature heat medium to the low temperature heat medium is low. Therefore, heat transfer is appropriately performable from the high-temperature heat medium circuit 20 to the low-temperature heat medium circuit 40.

The control device 60 estimates the amount of heat possessed by the high temperature heat medium based on the temperature of the high temperature heat medium. Thus, the amount of heat possessed by the high temperature heat medium is determined simply and appropriately based on the temperature of the high temperature heat medium, making it possible to appropriately transfer heat from the high-temperature heat medium circuit 20 to the low-temperature heat medium circuit 40.

### Fourth Embodiment

In the third embodiment described above, the operation of the high-temperature side flow rate adjustment valve 26 is controlled based on the amount of heat possessed by the high temperature heat medium. However, in the present embodiment, the operation of a high-temperature side flow rate adjustment valve 26 is controlled based on the amount of heat possessed by the low temperature heat medium.

That is, in step S100, when it is determined that the temperature of the low temperature heat medium (hereinafter referred to as a low temperature heat medium temperature) detected by a sixth heat medium temperature sensor 63f is lower than a first threshold value (for example, −10 degrees of Celsius), it is estimated that the amount of heat possessed by the low temperature heat medium is small, and therefore it is determined that the startup condition is satisfied.

In step S120, when it is determined that the low temperature heat medium temperature is higher than the first threshold value (e.g., −10 degrees of Celsius) and lower than a second threshold value (e.g., 30 degrees of Celsius), it is estimated that the amount of heat possessed by the low temperature heat medium is approximately intermediate, and therefore it is determined that the normal condition is satisfied.

In the present embodiment, a control device 60 controls the high-temperature side flow rate adjustment valve 26 so that the heat transfer unit flow rate ratio increases as the amount of heat possessed by the low temperature heat medium decreases. According to the above, similar to the third embodiment described above, it is possible to prioritize the heat transfer from the high temperature heat medium to the low temperature heat medium to provide the capacity of the refrigeration cycle 10 when the priority of heat transfer from the high temperature heat medium to the low temperature heat medium is high, e.g., in a low temperature environment, and, it is also possible to prevent the situation of (i) causing the unstable state of the cycle due to an excessive rise in the refrigerant pressure or (ii) causing an insufficient supply of heat to the heater core 23 in the high-temperature heat medium circuit 20. Therefore, heat is appropriately transferrable from the high-temperature heat medium circuit 20 to the low-temperature heat medium circuit 40.

The control device 60 estimates the amount of heat possessed by the low temperature heat medium based on the temperature of the low temperature heat medium. Thus, the amount of heat possessed by the low temperature heat medium is determinable simply and appropriately based on the temperature of the low temperature heat medium, making it possible to transfer heat appropriately from the high-temperature heat medium circuit 20 to the low-temperature heat medium circuit 40.

### Other Embodiments

The present disclosure is not limited to the above-described embodiments, but various modifications can be made as described in the following.
(1) In the above-described embodiment, the startup flow rate ratio in step S110 is set to 100%, and the excess capacity flow rate ratio in step S140 is set to 0%. However, the startup flow rate ratio and the excess capacity flow rate ratio may be changed depending on the density of the refrigerant, the amount of heat possessed by the high temperature heat medium, or the amount of heat possessed by the low temperature heat medium.

For example, the startup flow rate ratio and the excess capacity flow rate ratio may be increased as the density of the refrigerant, the amount of heat possessed by the high temperature heat medium, or the amount of heat possessed by the low temperature heat medium decreases.
(2) In the above-described embodiments, the refrigeration cycle 10 is configured as a circuit in which the inside evaporator 15 and the chiller 16 are connected in parallel. However, the present disclosure is not limited to such configuration. The refrigeration cycle of the thermal management system according to the present disclosure may include other configurations as long as it has a radiator that exchanges heat with a high temperature heat medium and a heat absorber that absorbs heat from a low temperature heat medium.
(3) The configuration of the high-temperature heat medium circuit in the present disclosure is not limited to those described in the above-described embodiments. For example, a high-temperature heat medium circuit 20 may include additional configuration other than those described in the above-described embodiments.
(4) The configuration of the low-temperature heat medium circuit in the present disclosure is not limited to those described in the above-described embodiments. For example, a low-temperature heat medium circuit 40 may include additional configuration other than those described in the above-described embodiments.
(5) In the above embodiment, the heating mode is described as an example of an operation mode in which the refrigeration cycle 10 is operated in a low temperature environment. However, the present disclosure is not limited to such mode. That is, the operation of a high-temperature side flow rate adjustment valve 26 according to the present disclosure is applicable to various operation modes other than the heating mode.

The technical items of the refrigeration cycle device disclosed in the present specification may include follows.

### Item 1

A refrigeration cycle device includes: a compressor (11) configured to draw and discharge a refrigerant; a radiator (12) used as a first heat exchanger in which the refrigerant discharged from the compressor exchanges heat with a high temperature heat medium to radiate heat to the high temperature heat medium; a decompressor (14b) used as a decompression valve configured to decompress the refrigerant flowing out from the radiator; a heat absorber (16) used as a second heat exchanger configured to exchange heat between the refrigerant decompressed in the decompressor and a low temperature heat medium; a high-temperature heat medium circuit (20) in which the high temperature heat medium circulates through the radiator; a heat supply target (23) arranged in the high-temperature heat medium circuit to be supplied with heat from the high temperature heat medium; a low-temperature heat medium circuit (40) in which the low temperature heat medium circulates through the heat absorber; a heat transfer unit (30) used as a heat transfer heat exchanger configured to transfer heat from the high-temperature heat medium circuit to the low-temperature heat medium circuit; a flow rate ratio adjuster (26) used as a flow adjustment valve configured to adjust a flow ratio of a flow rate of the high temperature heat medium flowing in the heat transfer unit to a flow rate of the high temperature heat medium circulating in the high-temperature heat medium circuit; and a control unit (60) used as a controller configured to control the flow rate ratio adjuster to cause the flow ratio to increase, as a density of the refrigerant, an amount of heat possessed by the high temperature heat medium, or an amount of heat possessed by the low temperature heat medium decreases.

### Item 2

In the refrigeration cycle device according to item 1, the control unit (60) controls the flow rate ratio adjuster (26), to cause the flow ratio to
(i) become a maximum ratio when the density of the refrigerant, the amount of heat possessed by the high temperature heat medium, or the amount of heat possessed by the low temperature heat medium is in a range lower than an intermediate range,
(ii) to become an intermediate ratio when the density of the refrigerant, the amount of heat possessed by the high temperature heat medium, or the amount of heat possessed by the low temperature heat medium is in the intermediate range, and
(iii) to becomes a minimum ratio when the density of the refrigerant, the amount of heat possessed by the high temperature heat medium, or the amount of heat possessed by the low temperature heat medium is in a range higher than the intermediate range.

### Item 3

In the refrigeration cycle device according to item 2, the control unit (60) sets the maximum ratio to 100% and the minimum ratio to 0%.

### Item 4

In the refrigeration cycle device according to item 2, wherein the control unit (60) increases the intermediate ratio as the density of the refrigerant, the amount of heat of the high temperature heat medium, or the amount of heat of the low temperature heat medium decreases.

### Item 5

In the refrigeration cycle device according to any one of items 1 to 4, the control unit (60) estimates the density of the refrigerant based on a pressure of the refrigerant after discharging from the compressor and before decompression by the decompressor.

### Item 6

In the refrigeration cycle device according to any one of items 1 to 4, wherein
the control unit (60) estimates the density of the refrigerant based on a pressure of the refrigerant after decompression by the decompressor and before being drawn into the compressor.

### Item 7

In the refrigeration cycle device according to any one of items 1 to 4, the control unit (60) estimates the amount of heat possessed by the high temperature heat medium based on the temperature of the high temperature heat medium.

### Item 8

In the refrigeration cycle device according to any one of items 1 to 4, the control unit (60) estimates the amount of heat possessed by the low temperature heat medium based on the temperature of the low temperature heat medium.

### Item 9

The refrigeration cycle device according to any one of items 1 to 8, further includes a low-temperature side heat supply unit (44) arranged in the low-temperature heat medium circuit (40) to generate a greater amount of heat as a travel load of a vehicle increases. In this case, the control unit (60) controls the flow rate ratio adjuster (26) to cause the flow ratio to be smaller when the travel load is predicted to enter a high load range than that when the travel load is predicted not to enter the high load range.

### Item 10

The refrigeration cycle device according to any one of items 1 to 9 further includes: a high-temperature side heat supply unit (25) arranged in the high-temperature heat medium circuit to supply heat to the high temperature heat medium; and a high-temperature side switching unit (27) arranged in the high-temperature heat medium circuit to switch between flow and no flow of the high temperature heat medium to the high-temperature side heat supply unit (25). In this case, the control unit (60) controls the high-temperature side switching unit (27) (i) to cause the high temperature heat medium to not flow to the high-temperature side heat supply unit (25) when the temperature of the high-temperature side heat supply unit (25) is lower than a predetermined temperature, and, (ii) to cause the high temperature heat medium to flow to the high-temperature side heat supply unit (25) when the temperature of the high-temperature side heat supply unit (25) is higher than the predetermined temperature.

### Item 11

The refrigeration cycle device according to any one of items 1 to 9 further includes: a low-temperature side heat supply unit (44) arranged in the low-temperature heat medium circuit to supply heat to the low temperature heat medium; and a low-temperature side switching unit (42) arranged in the low-temperature heat medium circuit to switch between flow and no flow of the low temperature heat medium to the low-temperature side heat supply unit (44). In this case, the control unit (60) controls the low-temperature side switching unit (42) (i) to cause the low temperature heat medium to not flow to the low-temperature side heat supply unit (44) when the temperature of the low-temperature side heat supply unit (44) is lower than a predetermined temperature, and (ii) to cause the low temperature heat medium to flow to the low-temperature side heat supply unit (44) when the temperature of the low-temperature side heat supply unit (44) is higher than the predetermined temperature.

Although the present disclosure has been described in accordance with examples, it is understood that the present disclosure is not limited to the examples and structures. The present disclosure also includes various modifications, and modifications within an equivalent scope. In addition, various combinations and modes, and other combinations and modes including only one element, more elements, or less elements are also within the scope and idea of the present disclosure.

What is claimed is:

1. A refrigeration cycle device comprising:
a compressor configured to draw and discharge a refrigerant;
a radiator in which the refrigerant discharged from the compressor exchanges heat with a high temperature heat medium to radiate heat to the high temperature heat medium;
a decompressor configured to decompress the refrigerant flowing out from the radiator;
a heat absorber configured to exchange heat between the refrigerant decompressed in the decompressor and a low temperature heat medium;
a high-temperature heat medium circuit in which the high temperature heat medium circulates through the radiator;
a heat supply target arranged in the high-temperature heat medium circuit to be supplied with heat from the high temperature heat medium;
a low-temperature heat medium circuit in which the low temperature heat medium circulates through the heat absorber;
a heat transfer unit configured to transfer heat from the high-temperature heat medium circuit to the low-temperature heat medium circuit;
a flow rate ratio adjuster configured to adjust a flow ratio of a flow rate of the high temperature heat medium flowing in the heat transfer unit to a flow rate of the high temperature heat medium circulating in the high-temperature heat medium circuit; and
a control unit configured to control the flow rate ratio adjuster to cause the flow ratio to increase, as a density of the refrigerant, an amount of heat possessed by the high temperature heat medium, or an amount of heat possessed by the low temperature heat medium decreases.

2. The refrigeration cycle device according to claim 1, wherein
the control unit controls the flow rate ratio adjuster, to cause the flow ratio to
(i) become a maximum ratio when the density of the refrigerant, the amount of heat possessed by the high temperature heat medium, or the amount of heat possessed by the low temperature heat medium is in a range lower than an intermediate range,
(ii) to become an intermediate ratio when the density of the refrigerant, the amount of heat possessed by the high temperature heat medium, or the amount of heat possessed by the low temperature heat medium is in the intermediate range, and
(iii) to becomes a minimum ratio when the density of the refrigerant, the amount of heat possessed by the high temperature heat medium, or the amount of heat possessed by the low temperature heat medium is in a range higher than the intermediate range.

3. The refrigeration cycle device according to claim 2, wherein
the control unit sets the maximum ratio to 100% and the minimum ratio to 0%.

4. The refrigeration cycle device according to claim 2, wherein
the control unit increases the intermediate ratio as the density of the refrigerant, the amount of heat possessed by the high temperature heat medium, or the amount of heat possessed by the low temperature heat medium decreases.

5. The refrigeration cycle device according to according to claim 1, wherein
the control unit estimates the density of the refrigerant based on a pressure of the refrigerant after discharging from the compressor and before decompression by the decompressor.

6. The refrigeration cycle device according to according to claim 1, wherein
the control unit estimates the density of the refrigerant based on a pressure of the refrigerant after decompression by the decompressor and before being drawn into the compressor.

7. The refrigeration cycle device according to according to claim 1, wherein
the control unit estimates the amount of heat possessed by the high temperature heat medium based on the temperature of the high temperature heat medium.

8. The refrigeration cycle device according to claim 1, wherein
the control unit estimates the amount of heat possessed by the low temperature heat medium based on the temperature of the low temperature heat medium.

9. The refrigeration cycle device according to according to claim 1, further comprising:
a low-temperature side heat supply unit arranged in the low-temperature heat medium circuit to generate a greater amount of heat as a travel load of a vehicle increases, wherein
the control unit controls the flow rate ratio adjuster to cause the flow ratio to be smaller when the travel load is predicted to enter a high load range than that when the travel load is predicted not to enter the high load range.

10. The refrigeration cycle device according to claim 1, further comprising:
a high-temperature side heat supply unit arranged in the high-temperature heat medium circuit to supply heat to the high temperature heat medium; and
a high-temperature side switching unit arranged in the high-temperature heat medium circuit to switch between flow and no flow of the high temperature heat medium to the high-temperature side heat supply unit, wherein
the control unit controls the high-temperature side switching unit (i) to cause the high temperature heat medium to not flow to the high-temperature side heat supply unit when the temperature of the high-temperature side heat supply unit is lower than a predetermined temperature, and, (ii) to cause the high temperature heat medium to flow to the high-temperature side heat supply unit when the temperature of the high-temperature side heat supply unit is higher than the predetermined temperature.

11. The refrigeration cycle device according to claim 1, further comprising:
a low-temperature side heat supply unit arranged in the low-temperature heat medium circuit to supply heat to the low temperature heat medium; and
a low-temperature side switching unit arranged in the low-temperature heat medium circuit to switch between flow and no flow of the low temperature heat medium to the low-temperature side heat supply unit, wherein
the control unit controls the low-temperature side switching unit (i) to cause the low temperature heat medium to not flow to the low-temperature side heat supply unit when the temperature of the low-temperature side heat supply unit is lower than a predetermined temperature, and (ii) to cause the low temperature heat medium to flow to the low-temperature side heat supply unit when the temperature of the low-temperature side heat supply unit is higher than the predetermined temperature.

12. A refrigeration cycle device comprising:
a compressor configured to draw and discharge a refrigerant;
a first heat exchanger in which the refrigerant discharged from the compressor exchanges heat with a high temperature heat medium to radiate heat to the high temperature heat medium;
a decompression valve configured to decompress the refrigerant flowing out from the radiator;
a second heat exchanger configured to exchange heat between the refrigerant decompressed in the decompression valve and a low temperature heat medium;
a high-temperature heat medium circuit in which the high temperature heat medium circulates through the first heat exchanger;
a heat supply target arranged in the high-temperature heat medium circuit to be supplied with heat from the high temperature heat medium;
a low-temperature heat medium circuit in which the low temperature heat medium circulates through the second heat exchanger;
a heat transfer heat exchanger configured to transfer heat from the high-temperature heat medium circuit to the low-temperature heat medium circuit;
a flow adjustment valve configured to adjust a flow ratio of a flow rate of the high temperature heat medium flowing in the heat transfer heat exchanger to a flow rate of the high temperature heat medium circulating in the high-temperature heat medium circuit; and
a controller including at least one of a circuit and a processor having a memory storing computer program code, wherein the at least one of the circuit and the processor having the memory is configured to control the flow adjustment valve to cause the flow ratio to increase, as a density of the refrigerant, an amount of heat possessed by the high temperature heat medium, or an amount of heat possessed by the low temperature heat medium decreases.

13. The refrigeration cycle device according to claim 12, wherein
the at least one of the circuit and the processor having the memory is configured to control the flow adjustment valve, to cause the flow ratio to
(i) become a maximum ratio in response to that the density of the refrigerant, the amount of heat possessed by the high temperature heat medium, or the amount of heat possessed by the low temperature heat medium is in a range lower than an intermediate range,
(ii) to become an intermediate ratio in response to that the density of the refrigerant, the amount of heat possessed by the high temperature heat medium, or the amount of heat possessed by the low temperature heat medium is in the intermediate range, and
(iii) to becomes a minimum ratio in response to that the density of the refrigerant, the amount of heat possessed by the high temperature heat medium, or the amount of heat possessed by the low temperature heat medium is in a range higher than the intermediate range.
